(19) United States
(12) Patent Application Publication
(10) Pub. No.: US 2015/0360435 A1
(43) Pub. Date: Dec. 17, 2015

(54) Process for assembly of corrugated pallets

(71) Applicants: Christopher W. Gabrys, Reno, NV (US); Joseph J. Danko, Apopke, FL (US); E. Neil Schopke, Rockledge, FL (US)

(72) Inventors: Christopher W. Gabrys, Reno, NV (US); Joseph J. Danko, Apopke, FL (US); E. Neil Schopke, Rockledge, FL (US)

(21) Appl. No.: 14/120,694

(22) Filed: Jun. 16, 2014

(51) Int. Cl. B31D 5/04; B31F 5/00

(52) U.S. Cl. CPC B31D 5/04; B31F 5/005

(57) ABSTRACT

A process for assembling a corrugated pallet having of two die cut corrugated paperboard blanks that form a pallet top and a pallet bottom, with each having at least one vertically extending double thickness rib, each rib having at least one notch, wherein said notches lock the opposing ribs from opening when the pallet top and pallet bottom are vertically nested together. In performance of the process a mix of machine and human performed operations is used. The machine forms the rib on each blank by applying in-plane pressure to the blank through protruding elements on the machine that engage the blank and move in relation towards each other, and the machine maintains the in-plane pressure to keep the rib from opening until a time after the pallet top and bottom are nested together. The machine uses rib folding plates that apply out-of-plane forces to the blanks to assist forming of the ribs by rotating in the out-of-plane direction when the in-plane compression is applied. Human operators load the blanks into the machine and form the sidewalls and fork openings.

This application is related to and claims priority for U.S. Provisional Application 61/835,547 filed on Jun. 15, 2013, and 61/929,454 filed on Jan. 20, 2014.

This invention pertains to pallets for shipping goods, and more particularly to a process for assembly of corrugated paperboard pallets that enables high volume pallet manufacturing with minimal assembly operator fatigue and with minimized assembly machine costs. The process increases manufacturing reliability and reduces the time required to assemble pallets.

### BACKGROUND OF THE INVENTION

Pallets are said to move the world. Eighty percent of commerce ships on pallets. The pallet industry is estimated at greater than $30 B worldwide. More than 500 million pallets are manufactured in the US each year, with 1.8 billion pallets in service in the US alone.

Pallets can be made from various materials, however wood pallets currently comprise about 80% of the market. More than 40% of worldwide hardwood lumber currently goes toward the manufacturing of wood pallets. Other materials used for pallet manufacturing include plastic, metal and corrugated paperboard.

Recent regulations regarding infestation and contamination are creating a surge in interest and use of non-wood pallet alternatives. A small, but fast growing segment is the use of corrugated paperboard pallets. Many desire to replace conventional wooden pallets with corrugated pallets: increasing ability to recycle, lowering pallet weight, eliminating product contamination, reducing pallet storage volume and reducing pallet related injuries.

Many different designs of corrugated paperboard pallets have been developed to date. Despite the potential advantages of corrugated pallets, many have suffered from several different deficiencies. These deficiencies include low strength and stiffness, high use of corrugated paperboard, resulting in high material costs, along with high overhead, assembly labor and freight costs. The inherent inability to readily produce and distribute corrugated pallets in sufficiently high volume has also been of critical importance.

Regardless of the design, it is desirable to increase the speed at which corrugated pallets can be produced. Corrugated pallets can be assembled solely by hand or by machine. When assembled by hand, the assembly time can be longer than acceptable for some high use applications and/or customers. When assembled by machine, the assembly speed can be increased, however the assembly machine size and costs are increased and this in turn makes the assembly upfront and operating costs to be higher than desirable for some customers and/or parts of the world. Accordingly, a new corrugated pallet assembly process is needed that can be used to readily produce corrugated pallets in high volume, at a high rate and with simultaneous low assembly costs.

### SUMMARY OF THE INVENTION

There are currently two general types of corrugated pallets; one type comprising blocks or runners of corrugated board that are stacked, rolled and/or assembled together and then bonded to top and bottom decks, and the other type comprising two sheets that are folded and assembled together to form top, bottom and integral vertical supports. The first type typically utilizes a high volume of corrugated paperboard and is expensive. Further compounding the high material costs is the complicated and time consuming assembly, which is typically done at an intermediate location, adding more logistical costs.

The second general type of corrugated pallet formed from two sheets with integral vertical supports between the two sheets is preferred because of much lower inherent board use. Regardless of the specific design, the assembly is typically accomplished in three steps; forming a top, forming a bottom and later assembly of the top with the bottom together. Although less costly than the first type of corrugated pallets because of lower material costs, manufacturing can be still too time consuming, involved and expensive.

A principle goal of the invention is to provide a process for assembly of corrugated pallets that enables high volume pallet manufacturing at a high rate with simultaneous low assembly costs. We have found that in the assembly of corrugated pallets, there are different folding and assembly operations and that some of these operations are difficult to conduct by persons by hand rapidly and repeatedly. These operations are also easily conducted by a machine. We have also found that some operations in the assembly of corrugated pallets are difficult to have performed by machine due to the required mechanical complexity, and resulting reduced reliability and greatly increased machine costs. We have found that these operations that are difficult to perform by machine are also surprisingly easy to be performed by persons by hand. This aspect of the disclosed preferred embodiments of invention therefore increases the assembly rate and reduces costs associated with corrugated pallet assembly by utilizing the synergy whereby pallet assembly is shared by both use of machine functions and person hand assembly functions. For example, operations that are difficult for persons but easy for a machine can be completed by machine, and operations that are difficult for a machine but easy by person by hand can be completed by person by hand. In the assembly process, the assembly functions can change back and forth between machine and person several times for optimal efficiency. The process reduces the time required to assemble pallets and reduces the assembly costs, with minimized assembly operator fatigue and minimized assembly machine complexity.

It is an additional goal of the invention to integrate assembly such that the process can be simplified and steps may be eliminated. For example, in the preferred embodiments, the forming of ribs can be integrated with the assembly of pallet top and bottom together. Prior art two piece pallets have ribs or vertical supports that are locked from opening by adhesive and/or mechanical locks self-contained on each separate piece. For instance, in U.S. Pat. No. 6,029,582 the individual ribs are locked together using jack flaps and sliding lock assemblies. U.S. Pat. No. 7,426,890 teaches locking of ribs using folding flap lock assemblies locked prior to nesting of pallet top and bottom using a slot and wing tab. U.S. Pat. No. 7,890,184 teaches locking support ribs using a gate flap and pass through aperture. U.S. Pat. No. 7,303,519 further teaches a machine for forming pallet tops and bottoms wherein the ribs are locked from opening through the use of adhesive. In each case, independently locked ribs provide the benefit of robust ribs that may stay intact even if pallet becomes partially disassembled.

The drawback of self-locked ribs however is that extra steps and complexity of the assembly process are required. We have found that the assembly of pallet top blank nested with pallet bottom blank can be sufficient to keep ribs locked for most pallet use. Locking of ribs from opening in this way is achieved by notches in the top ribs locking the bottom ribs from opening, and notches in the bottom ribs locking the top ribs from opening. The completion of the sides of the pallet is utilized to hold the pallet top and pallet bottom blanks together such that ribs stay locking each other. Added machine requirements of maintaining the ribs of top and bottom folded under pressure until top and bottom are nested together are desirable. However, the pallet assembly steps and time for self-locking of individual ribs can be eliminated, along with attendant substantial machine complexity and size reduction. The preferred embodiment of the invention provides a process for assembling a corrugated pallet using a mix of machine and human performed operations. An example of a corrugated pallet that can be assembled with the process of this invention includes two die cut corrugated paperboard blanks that form a pallet top and a pallet bottom. The pallet top and pallet bottom each have at least one vertically extending double thickness rib, and each rib has at least one notch, wherein the notches lock the opposing ribs from opening when the ribs on the pallet top and the pallet bottom are vertically nested together. A machine operating in accordance with this invention forms the rib on each blank by applying in-plane pressure to the blank through protruding elements on the machine that penetrate the blank or engage the edges of the blank and move in relation towards each other, and the machine maintains the in-plane pressure to keep the rib from opening until a time after the pallet top and the pallet bottom are nested together. The use of protruding elements or pins that penetrate the blanks allows for sufficiently high in-plane compression force for reliable folding of ribs.

It is desirable for the pallet assembly process to occupy the minimal amount of space for both reduction of required floor space and also reduction of the size and cost of the assembly machine. We have designed the preferred embodiments of the invention to allow the ribs on the pallet top and bottom to be formed while the blanks are vertically aligned in a horizontal position, thereby allowing the pallet top and bottom to be vertically assembled together in the same location. In an additional embodiment of the invention, the machine forms the ribs on both the pallet top and the pallet bottom and nests the pallet top and the pallet bottom together so that forming and nesting occur without bodily in-plane translation of one or both of the blanks.

For simplicity of the machine design, it is preferable to hold the blanks from only one side instead of two. Holding blanks from both the top and bottom sides results in machine parts necessarily located between the two blanks, significantly complicating the assembly and nesting of the pallet top and pallet bottom in the same location. Such machine parts would have to be moved or the blanks moved to allow nesting of the pallet top and pallet bottom. In a further embodiment of the invention, the machine utilizes vacuum to hold each blank in a fixed position while protruding elements provide in-plane pressure. In this case, the top blank is held using vacuum from the top side and the bottom blank is held using vacuum from the bottom side. Pins though each blank move toward each other to provide in-plane compression for rib folding. In-plane pressure is maintained until after the top and bottom are nested together.

During the folding of the ribs for the pallet top and pallet bottom through application of in-plane compression, there is a tendency for the ribs to fold in either the correct direction or 180 degrees opposite. For instance, ribs from the top blank should fold such that they extend downward while ribs from the bottom blank should fold such that they fold upward. To assist folding in the desired out-of-plane directions, it is desirable to apply out-of-plane force to the ribs in formation. In an additional embodiment, the machine further comprises rib folding plates that apply out-of-plane forces to the blanks to assist forming of the ribs by rotating in the out-of-plane direction when the in-plane pressure is applied. Out-of-plane force could be applied by several different means however the use of rib folding plates moving in the out-of-plane direction affords simple machine construction. More preferably, the machine further comprises rib folding plates that apply out of plane forces to the blanks to assist forming of the ribs in the desired out-of-plane directions by rotating about a fixed axis in the out-of-plane direction when in-plane compression is applied.

A drawback to this method is that the folding plates become trapped between the two sides of the ribs when folded, once rotated vertically. Surprisingly, we have found that this can be advantageous in that it can be used to maintain the ribs more accurately vertical for easier nesting of the pallet top and pallet bottom. After the pallet assembly is completed, the pallet may be vertically removed from the rib folding plates to remove the pallet from the machine. In yet an additional embodiment of the invention, the rib folding plates stay inside the ribs once formed until after the pallet top and the pallet bottom are nested together.

The assembly process of maintaining in-plane pressure to keep the ribs from opening against board memory until after the top and bottom are nested eliminates the need for self contained rib locks or the use of adhesives. Adhesives add significant costs and machine complexity as well as reduce machine reliability. Adhesives also require time to set. Likewise, integral mechanical rib locks on each blank would require machinery to engage inside the space between both the pallet top and pallet bottom, hindering nesting of the pallet top and bottom together at the same location. In a further embodiment, the assembly process utilizes no integral corrugated mechanical or adhesive locking of the ribs from opening prior to said nesting.

The process for assembling the corrugated pallet can be completed with both persons and machine for minimized assembly cost and assembly ease. Some tasks are best done by machine and other best done by person. Forming of ribs and nesting of the top and bottom together are best done by machine. Loading blanks and folding sidewalls is in many cases best done by person, since they are easy hand operations that are more difficult to automate. In an additional embodiment of the invention, at least one person loads the blanks into the machine, the machine forms the ribs, the machine nests the pallet top and the pallet bottom together, and at least one persons folds the sidewalls of the pallet in the out-of-plane direction.

The size of the machine for use with the disclosed assembly process is minimized through the use of rib folding that occurs with the blanks static. The process is more complicated than conventional corrugated folding performed by bodily moving blanks over fixed mandrels, for example on a conveyor belt, and is potentially slower. In a further embodiment, the machine forms the ribs on the blanks while bodily translationally static, and nests the pallet top and the pallet bottom together by both rotating the pallet top and for the pallet bottom so the top and bottom ribs are perpendicular to each other, and by moving the pallet top and/or the pallet bottom towards each other in the out-of-plane direction. Of course, the top and bottom blanks have portions that move in the in-plane direction inwardly during rib formation, but otherwise the blanks remain bodily static against in-plane translation.

### DESCRIPTION OF THE DRAWINGS

The invention and its many advantages and features will become better understood upon reading the following detailed description of the preferred embodiments in conjunction with the following drawings, wherein:

FIG. 1 is a flow diagram of a process for assembly of corrugated pallets in accordance with the invention.

FIG. 2 is a plan view of a set up to execute the process of FIG. 1 for assembly of corrugated pallets in accordance with the invention.

FIG. 3 is a schematic side elevation of a pallet assembly machine of FIG. 2.

FIG. 4 is a perspective drawing of a corrugated pallet assembled in accordance with the invention.

FIG. 5 is an exploded perspective drawing of a corrugated pallet in flat blank state to be assembled into a the pallet of FIG. 4.

FIG. 6 is an exploded perspective view of corrugated pallet blanks shown in FIG. 5, with opposing ribs folded in accordance with the invention.

FIG. 7 is a perspective drawing of top and bottom blanks of the corrugated pallet shown in FIG. 4, with ribs nested together in accordance with the invention.

FIG. 8 is a schematic drawing of the corrugated pallet shown in FIG. 7, with sidewalls tucked in accordance with the invention.

FIG. 9 is a perspective view of corrugated pallet shown in FIG. 8, with fork windows opened in accordance with the invention.

FIG. 10A is a schematic drawing of a configuration of a folding section of another embodiment of a pallet assembly machine. prior to folding ribs.

FIG. 10B is a schematic drawing of a configuration of the folding section of the pallet assembly machine of FIG. 10A. after folding ribs.

### DESCRIPTION OF THE PREFERRED EMBODIMENT

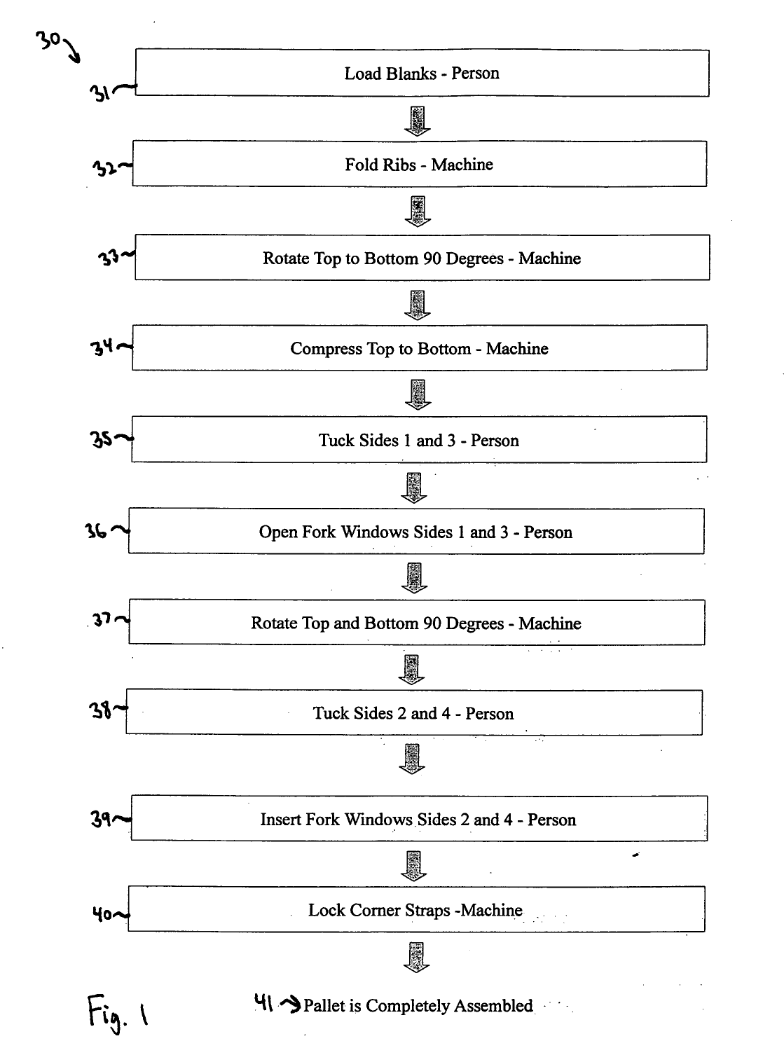

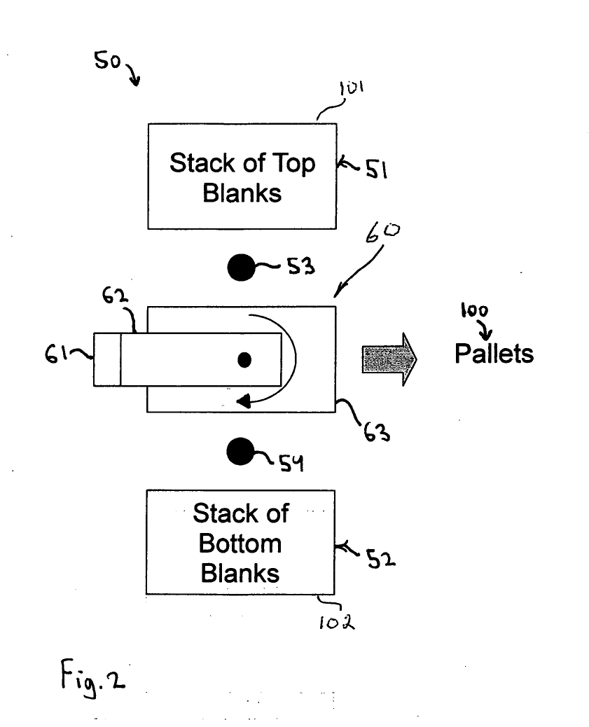

Turning to the drawings, wherein like reference characters designate identical or corresponding parts, and more particularly to FIGS. 1-3 thereof, FIG. 1 shows a preferred embodiment of a process for assembly of corrugated pallets in accordance with the invention. The process 30 comprises step 31: loading blanks 101,102 into the pallet assembly machine 60 by hand. In one embodiment illustrated in FIG. 2, one person (represented by icon 53) loads top blanks and another person (represented by icon 54) loads bottom blanks from opposite sides of the machine. Loading blanks from uneven and misaligned stacks of blanks is very easy by humans but difficult by machine. After the blanks are loaded, the next step 32 is folding ribs on top and bottom blanks 101, 102, which is preferably done by machine because it is difficult to do as quickly by hand since each blank needs to be gripped or held at several places at the same time. The third step 33 is to rotate the top blank to bottom blanks by 90 degrees such that they can be assembled together perpendicularly. This step is easily conducted by machine. After rotation, the fourth step 34 is to compress the top to bottom blanks 101, 102 together. Because the compression can take over 100 lbs of force to assemble the top to bottom, fully nesting the ribs of each together, this is best accomplished by machine. The fifth step 35 is to fold up and tuck in sides 1 and 3, which is difficult to do by machine due to motion complexity and required accuracy, but easy by a person due to low force required. The sixth step 36 is to open the fork windows of side 1 and 3, which is easily done by a person. The seventh step 37 is to rotate the top and bottom together by 90 degrees so that the sides 2 and 4 can be completed. This step is easily accomplished by machine. The eighth step 38 is to fold up and tuck in sides 2 and 4, again preferably done by a person. The ninth step 39 is to insert the fork windows in sides 2 and 4, which is easily done by hand where a machine would require significant mechanical complexity. The last step in the process 30 is the locking of the corner straps 40. This operation could be done by machine or by person relatively easily.

A plan view of a set up to execute the process of FIG. 1 for assembly of corrugated pallets in accordance with the invention is shown in FIG. 2. The set up 50 comprises a stack 51 of top blanks 101, a stack 52 of bottom blanks 102 and two human operators 53, 54. The operators 53, 54 load blanks 101, 102 into the pallet assembly machine 60. The machine 60 comprises a vertical beam support 61 and a top cantilever support 62. The top blanks are loaded into the top frame 63. The assembly process may alternatively be accomplished by putting both sets of blanks 51, 52 on the same side of the assembly machine and then a single operator 53 loading both blanks one after the other.

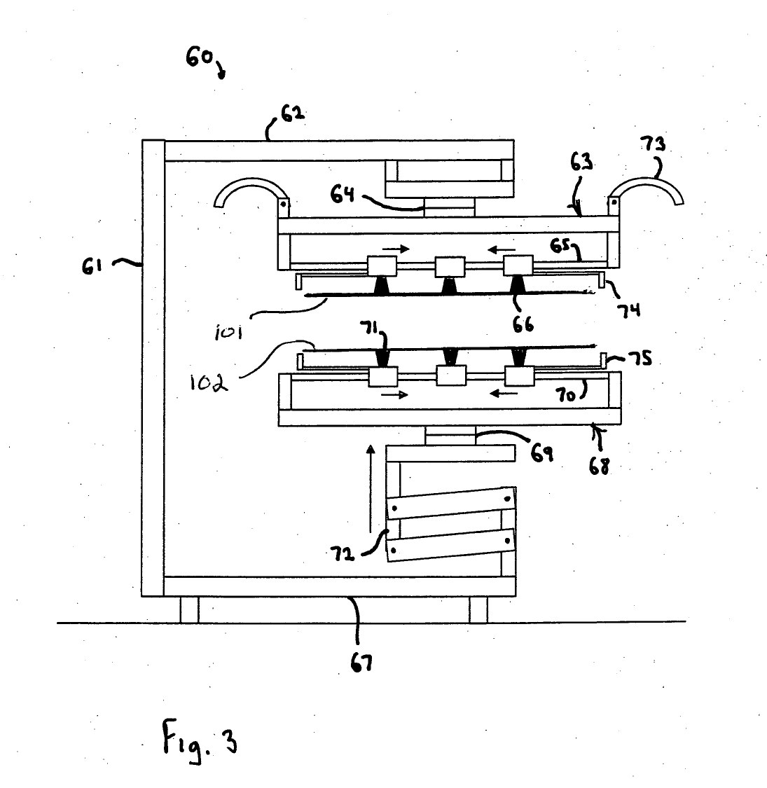

A side elevation of the pallet assembly machine 60 shown in FIG. 2 for assembling corrugated pallets in accordance with the invention is shown in FIG. 3. The assembly machine is preferably powered by pneumatic cylinders, which are omitted from the drawing for simplicity and clarity of the overall machine functioning. The machine preferably operates with sensors that sense when the top and bottom blanks 101, 102 have been loaded. The sensors, not shown, trigger the start of the rib forming timing sequence, which is preferably operated by a programmable logic controller. The sensors may be blank sensors or alternatively foot switches that are triggered by an assembly operator.

The machine 60 comprises a vertical beam support 61, a top cantilever support 62 and a bottom support 67. A top frame 63 is supported below the top cantilever support 62 by a bearing 64 to allow for rotation of the pallet top. Mounted on the top frame 63 is a slide support 65, supporting three rows of vacuum cups 66 that are used to grip the top blank 101, slide together while two parallel ribs are formed in the top blank 101. When the vacuum cups 66 suck the top blank 101 up against stops, the elements 74 engage the top blank 101 at the edges to apply in-plane pressure to fold the ribs as the vacuum cups 66 slide inward to hold portions of the top blank in-plane as they move inward toward each other.

The bottom frame 68 is supported above the bottom support 67 through a lift linkage 72 and a bottom bearing 69. Mounted on the bottom frame 68 is a slide support 70, supporting three rows of vacuum cups 71 that are used to grip the bottom blank 102, slide together and form two parallel ribs of the bottom blank 102. When the vacuum cups 71 suck the bottom blank 102 down against stops, the elements 75 engage the bottom blank at the edges to apply in-plane pressure for folding the ribs, while the vacuum cups 71 hold portions of the top blank in-plane as they move inward toward each other while the ribs are formed. After the top and bottom blanks 101, 102 have ribs formed and are vertically compressed together by the lift linkage 72, and sidewalls are hand assembled, the corner straps of the pallet are assembled by arms 73 on the assembly machine 60. The corner straps may alternatively be assembled by person by hand.

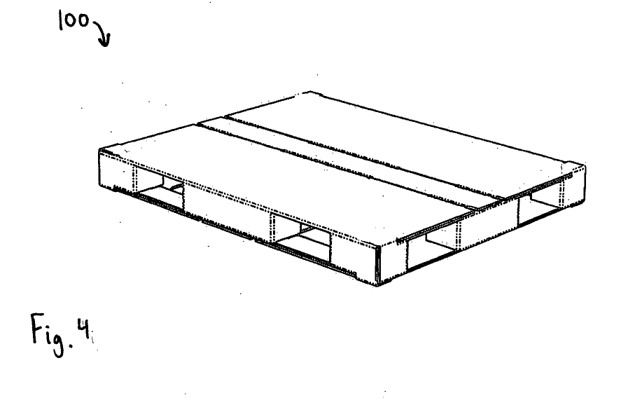

A perspective view of a corrugated pallet 100 assembled in accordance with the invention is shown in FIG. 4. The pallet 100 is constructed from two sheets of corrugated paperboard comprising the pallet top and pallet bottom that are folded together. We have in mind other configurations of corrugated pallet that could also be assembled in accordance with the invention. The pallet 100 can have either four way entry holes or two way entry holes for forks or pallet jacks used to move the pallet.

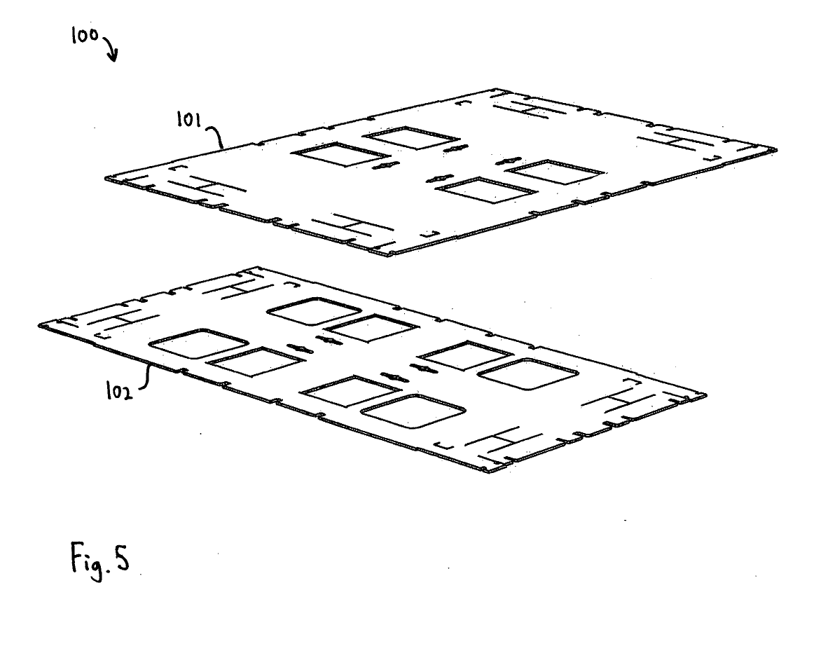

The corrugated pallet 100 shown in FIG. 4 is shown in FIG. 5 in flat blank state. The pallet 100 is comprised of a top blank 101 and a bottom blank 102. The blanks 101, 102 are die cut for easy and accurate folding to make the finished pallet. The die that cuts the blanks 101, 102 installs cuts and also scores into the blanks.

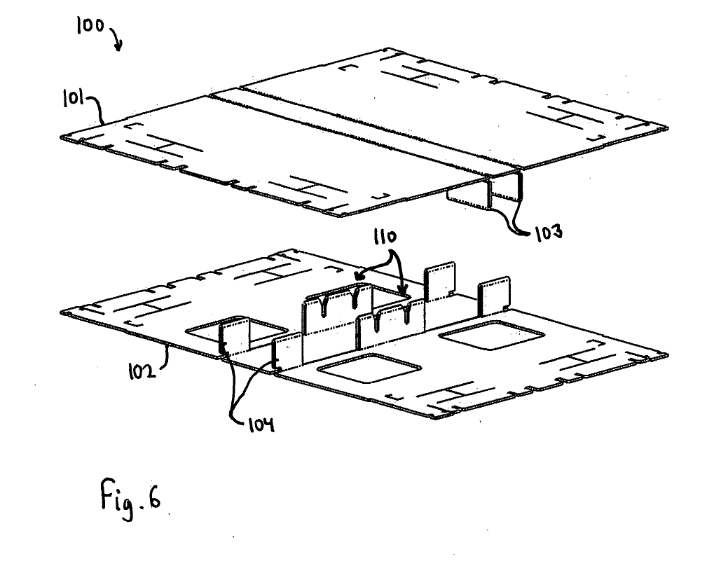

In FIG. 6, the pallet 100 shown in FIGS. 4 and 5 gains internal vertical support structure by vertical ribs 103,104 being folded into the pallet top and bottom 101, 102. Notches 110 in the bottom ribs 104 lock the top ribs 103 from opening when the pallet top 101 is vertically nested together with the pallet bottom 102. Likewise, notches, not shown, in the ribs of the pallet top 101 lock the bottom ribs 104 from opening when pallet top 101 and pallet bottom 102 are vertically nested together.

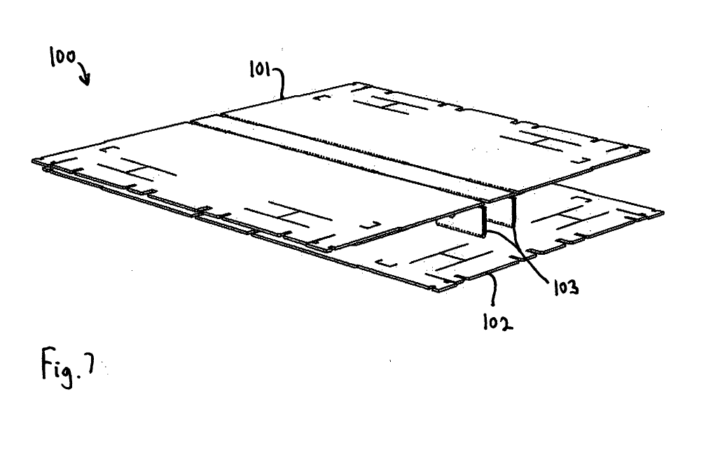

In FIG. 7, the pallet top 101 and bottom 102 have been rotated 90 degrees, as shown in FIG. 6, and compressed together. Notches in the ribs 103 intersect and lock perpendicularly into corresponding notches 110 in ribs 104. This provides cross support for the pallet 100 and also utilizes each set of ribs 103, 104 to lock each other from opening.

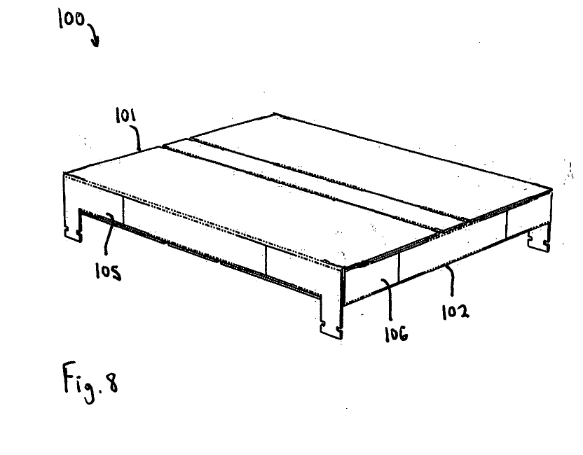

The corrugated pallet 100 shown in assembly in FIGS. 5-7 is shown in FIG. 8 with sidewalls tucked in accordance with the invention. After the top and bottom blanks 101, 102 are compressed together, a person or persons preferably completes the sidewalls 105, 106 of the pallet by tucking them in. This operation forms the sidewalls 105 from the pallet top 101 and the sidewalls 106 from the pallet bottom.

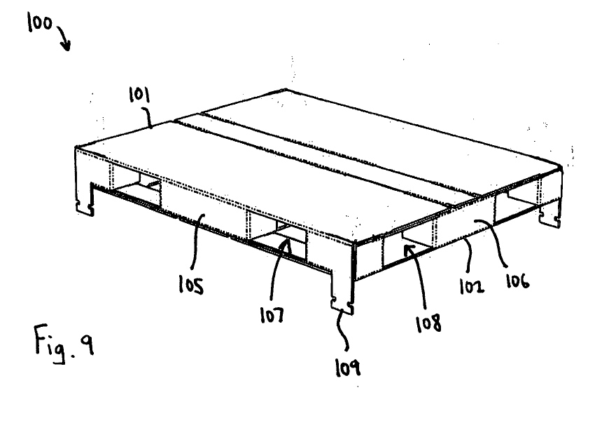

The corrugated pallet 100 shown in assembly in FIGS. 5-8 is shown in FIG. 9 with fork windows opened in accordance with the invention. After sidewalls 105, 106 have been tucked in (steps 35 and 38), the next operation (step 39) is to open the fork windows in the pallet 100. The pallet top 101 forms sidewalls 105 and cuts and scores in the blank provide for fork openings 107. The pallet bottom 102 forms sidewalls 106 and cuts and scores in the blank provide for fork openings 108. The openings 108 are opened simply by pushing the blank sidewalls in where the blanks have been pre-cut to allow the paperboard to swing in. The last step is locking the corner locks 109 that extend from the top blank 101 and overlap and enter in the bottom of the bottom blank 102. The corner locks shown on the bottom blank 102 are not used in this embodiment to maintain a smooth top for the pallet 100.

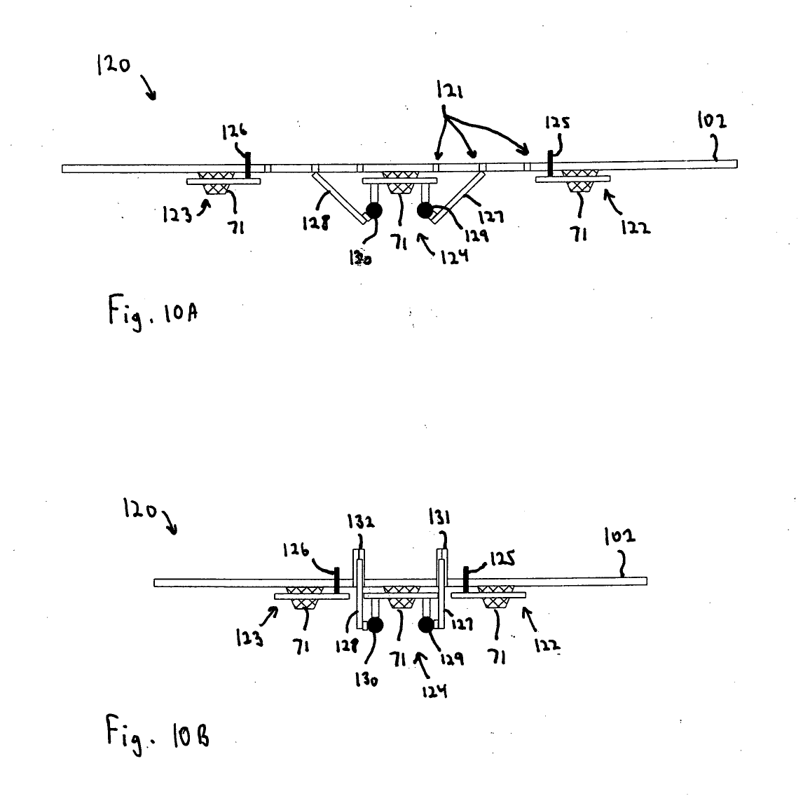

A schematic drawing of a configuration of the folding section of the pallet assembly machine of FIG. 3. is shown in FIG. 10A, prior to folding ribs. The folding section 120 folds vertically, folding double thickness ribs 131, 132 into bottom blank 102. Prior to folding ribs, the blank 102 is flat. The blank 102 is placed onto the folding section 120 by setting the blank over protrusions 125, 126 on the sliding portions 122, 123 that penetrate the blank. A benefit of using pins 125, 126 that penetrate the blank 102 is that the pins can be used to accurately position the blanks into the machine as well as provide high in-plane pressure for rib folding. Sliding elements 122, 123 and center portion 124 have vacuum cups 71 that suck the blank 102 down. After penetrating the blank 102, protrusions or pins 125, 126 apply in-plane compression to the blank through bearing force as sliding sections 122, 123 are forced inward toward the center element 124. The blank 102 preferably comprises scores 121 that bend and facilitate upward folding of the ribs 131, 132, out of plane, as shown in FIG. 10B. Rib folding plates 127, 128 supported by rotary bearings 129, 130 contact the blank 102 near the center scores 121 that later form the rib top of both ribs, to initiate rib folding of. As in-plane compression is applied, suction cups hold the non-folding portions of the blank 102 in-plane while the rib folding plates 127, 128 rotate vertically, applying out-of-plane force to the blank causing the ribs to fold in the desired direction.

A schematic drawing of a configuration of the folding section of the pallet assembly machine of FIG. 3. after folding ribs is shown in FIG. 10 B. The sliding portions 122, 123 have slid inward toward the center portion 214 and rib folding plates 127, 128 have rotated vertically forming ribs 131, 132. The rib folding plates 127, 128 are trapped inside the double thickness ribs 131, 132 and hold them to be accurately vertical, allowing top and bottom blanks to later be easily assembled together. Upon completion of the pallet, vacuum is removed from vacuum cups 71 and the pallet is vertically slid off of the rib folding plates 131, 132 and protrusions 125, 126 prior to rotating rib folding plates open and sliding of sliding portions outward.

Obviously, numerous modifications and variations of the described preferred embodiment are possible and will occur to those skilled in the art in light of this disclosure of the invention. Accordingly, I intend that these modifications and variations, and the equivalents thereof, be included within the spirit and scope of the invention as defined in the following claims, wherein I claim:

1. A process for assembling a corrugated pallet using a machine comprising:
a corrugated pallet comprised of two die-cut corrugated paperboard blanks that form a pallet top and a pallet bottom;
said pallet top and said pallet bottom each having at least one vertically extending double thickness rib, said ribs on said pallet top and bottom opposing each other, each said rib having at least one notch aligned with the notch on said opposing rib, wherein said notches lock said opposing ribs from opening when said pallet top and said pallet bottom are vertically nested together;
said machine forms said rib on each said blank by applying in-plane pressure to said blank through protruding elements on said machine that penetrate said blank and move in relation towards each other, and said machine maintains said in-plane pressure to keep said rib from opening until a time after said pallet top and said pallet bottom are nested together.

2. A process for assembling a corrugated pallet using a machine as described in claim 1, wherein:
said machine forms said ribs on both said pallet top and said pallet bottom and nests said pallet top and said pallet bottom together wherein said forming and said nesting occur without in-plane bodily translation of one or both of said blanks.

3. A process for assembling a corrugated pallet using a machine as described in claim 1, wherein:
said machine utilizes vacuum to hold each said blank in a fixed position while said protruding elements provide said in-plane pressure.

4. A process for assembling a corrugated pallet using a machine as described in claim 1, wherein:
said machine further comprises rib folding plates that apply out of plane forces to said blanks to assist forming of said ribs by moving in an out-of-plane direction when said in-plane pressure is applied.

5. A process for assembling a corrugated pallet using a machine as described in claim 4, wherein:
said rib folding plates remain inside said ribs once formed until after said pallet top and said pallet bottom are nested together.

6. A process for assembling a corrugated pallet using a machine as described in claim 1, wherein:
said ribs are free of integral corrugated mechanical or adhesive locking to prevent opening prior to said nesting.

7. A process for assembling a corrugated pallet using a machine as described in claim 1, wherein:
at least one person loads said blanks into said machine, said machine forms said ribs, said machine nests said pallet top and said pallet bottom together, and at least one persons folds sidewalls of said pallet in an out-of-plane direction.

8. A process for assembling a corrugated pallet using a machine comprising:
a corrugated pallet comprised of two die cut corrugated paperboard blanks that form a pallet top and a pallet bottom;
said pallet top and said pallet bottom each having at least one vertically extending double thickness rib, said ribs on said pallet top and bottom opposing each other, each said rib having at least one notch, wherein said notches lock the opposing said ribs from opening when said pallet top and said pallet bottom are vertically nested together;
said machine forms said rib on each said blank by applying in-plane pressure to said blank through elements on said machine that engage said blank and move in relation towards each other, and said machine maintains said in-plane pressure to keep said rib from opening until a time after said pallet top and said pallet bottom are nested together;
said machine forms said ribs of both said pallet top and said pallet bottom and nests said pallet top and said pallet bottom together wherein said forming and said nesting occur without bodily in-plane translation of either of said blanks.

9. A process for assembling a corrugated pallet using a machine as described in claim 8, wherein:
said machine utilizes vacuum to hold each said blank in a fixed position while said elements provide said in-plane pressure.

10. A process for assembling a corrugated pallet using a machine as described in claim 8, wherein:
said machine further comprises rib folding plates that apply out of plane forces to said blanks to assist forming of said ribs by rotating in the out-of-plane direction when said in-plane pressure is applied.

11. A process for assembling a corrugated pallet using a machine as described in claim 10, wherein:
said rib folding plates stay inside said ribs once formed until after said pallet top and said pallet bottom are nested together.

12. A process for assembling a corrugated pallet using a machine as described in claim 8, wherein:
no integral corrugated mechanical or adhesive locking of said ribs from opening is utilized prior to said nesting.

13. A process for assembling a corrugated pallet using a machine as described in claim 8, wherein:
at least one person loads said blanks into said machine, said machine forms said ribs, said machine nests said pallet top and said pallet bottom together, and at least one persons folds the sidewalls of said pallet in the out-of-plane direction.

14. A process for assembling a corrugated pallet using a machine as described in claim 8, wherein:
said machine forms said ribs on said blanks while said blanks are bodily translationally static and nests said pallet top and said pallet bottom together by both rotating said pallet top and/or said pallet bottom and by moving said pallet top and/or said pallet bottom towards each other in the out-of-plane direction.

15. A process for assembling a corrugated pallet using a machine comprising:
a corrugated pallet comprised of two die cut corrugated paperboard blanks that form a pallet top and a pallet bottom;
said pallet top and said pallet bottom each having at least one vertically extending double thickness rib, each said rib having at least one notch, wherein said notches lock the opposing said ribs from opening when said pallet top and said pallet bottom are vertically nested together;
said machine forms said rib on each said blank by applying in-plane pressure to said blank through protruding elements on said machine that engage said blank and move in relation towards each other, and said machine maintains said in-plane pressure to keep said rib from opening until a time after said pallet top and said pallet bottom are nested together;
said machine further comprises rib folding plates that apply out-of-plane forces to said blanks to assist forming of said ribs by rotating in the out-of-plane direction when said in-plane compression is applied.

16. A process for assembling a corrugated pallet using a machine as described in claim 15, wherein:
said rib folding plates stay inside said ribs once formed until after said pallet top and said pallet bottom are nested together.

17. A process for assembling a corrugated pallet using a machine as described in claim 15, wherein:
said machine utilizes vacuum to hold each said blank in a fixed position while said elements provide said in-plane pressure.

18. A process for assembling a corrugated pallet using a machine as described in claim 15, wherein:
at least one person loads said blanks into said machine, said machine forms said ribs, said machine nests said pallet top and said pallet bottom together, and at least one persons folds the sidewalls of said pallet in the out-of-plane direction.

19. A process for assembling a corrugated pallet using a machine as described in claim 15, wherein:
said machine forms said ribs on said blanks while translationally static and nests said pallet top and said pallet bottom together by both rotating said pallet top and/or said pallet bottom and by moving said pallet top and/or said pallet bottom towards each other in the out-of-plane direction.

20. A process for assembling a corrugated pallet using a machine as described in claim 15, wherein:
no integral corrugated mechanical or adhesive locking of said ribs from opening is utilized prior to said nesting.
